(19) United States
(12) Patent Application Publication
(10) Pub. No.: US 2026/0202908 A1
(43) Pub. Date: Jul. 16, 2026

(54) SYSTEMS AND METHODS FOR EXPERIENCING PHYSICAL ACTIONS IN VIRTUAL WORLD

(71) Applicant: Samsung Electronics Co., Ltd., Suwon-si (KR)

(72) Inventors: Dewanshu HASWANI, Bangalore (IN); Vijay Narayan TIWARI, Bangalore (IN); Anupam AGGARWAL, Bangalore (IN)

(21) Appl. No.: 19/564,709

(22) Filed: Mar. 12, 2026

Related U.S. Application Data
(63) Continuation of application No. PCT/KR2024/096180, filed on Sep. 19, 2024.

(30) Foreign Application Priority Data
Sep. 29, 2023 (IN) 202341065774

(51) Int. Cl. G06F 3/01; G06F 3/04815

(52) U.S. Cl. CPC G06F 3/011; G06F 3/04815

(57) ABSTRACT

Systems and methods for enabling a user to feel a physical action experience of one or more virtual objects in real world for enhancing user experience during virtual communications are provided. The systems and methods enable a user to feel an absolute weight of the virtual objects in the real world. The method estimates the physical action experience by distributing nano-magnetic particles to different regions of user's hand based on the virtual object held by user's avatar in the virtual world. The method controls a flow of nano-magnetic particles to different regions of the user's hand, based on the center of mass and contact points of the virtual object.

### CROSS-REFERENCE TO RELATED APPLICATION(S)

This application is a continuation application, claiming priority under 35 U.S.C. § 365 (c), of an International application No. PCT/KR2024/096180, filed on Sep. 19, 2024, which is based on and claims the benefit of an Indian Patent Application number 202341065774, filed on Sep. 29, 2023, in the Indian Intellectual Property Office, the disclosure of which is incorporated by reference herein in its entirety.

### BACKGROUND

### 1. Field

The disclosure relates to virtual communications. More particularly, the disclosure relates to enable a user to feel a physical action experience of a virtual object in real world for enhancing user experience.

### 2. Description of Related Art

One of the biggest challenges in creating social experiences is lack of tools available to create virtual environments that are immersive and realistic. Currently, users can feel the touch of an object and contraction in their fingers, in virtual sessions, based on shape of a virtual object. However, the users are unable to experience a physical action experience (such as physical force, pressure and weight of the virtual object), which breaks the link from reality.

Existing systems use a pneumatic feedback robot to carry out the interactive in-process of virtual environment with the user and provide omnidirectional temperature and mechanical feedback. Other systems provide apparatus for virtual-reality (VR) feedback biases or limits movement of various joints of a wearer's body so as to impart a feeling of physical properties of a virtual object. Other systems provide a hand control unit for VR devices that is specially designed for use in VR applications and games experienced with VR glasses. The hand control unit can make the user feel the weight of the objects as real in the VR applications and games by means of creating a tangible feeling of weight with a rotating ball and a software control integrated with the hand controller.

FIG. 1 illustrates an example block representation indicating user's experience in a virtual session while holding a virtual object according to the related art.

Referring to FIG. 1, the user can feel the touch of an object and contraction in their fingers, in the virtual session, based on shape of the virtual object. The existing systems have only been able to replicate the feeling of touch, pain, temperature and vibrations while holding the virtual object, using different mechanisms like electric pulses, air pressure, and so on. The existing systems do not allow users to experience the physical action (such as physical force, pressure and weight of the virtual object) of virtual objects.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide systems and methods for enabling a user to feel a physical action experience of one or more virtual objects in real world during virtual communications.

Another aspect of the disclosure is to provide systems and methods for enabling a user to feel an absolute weight of one or more virtual objects in the real world.

Another aspect of the disclosure is to provide systems and methods for estimating the physical action experience by distributing nano-magnetic particles to different regions of user's hand based on the virtual object held by user's avatar in the virtual world.

Additional aspects will be set forth in part in the description which follows and, in part, will be apparent from the description, or may be learned by practice of the presented embodiments.

In accordance with an aspect of the disclosure, a method for enabling a physical action experience in a virtual world is provided. The method includes detecting, by virtual reality (VR) circuitry, an interaction between an avatar and one or more virtual objects or between one or more avatars in the virtual world, recognizing, by the VR circuitry, that the interaction includes a physical action, measuring, by the VR circuitry, a magnitude of the physical action, and activating, by the VR circuitry, a device for emulating the physical action and the magnitude exerted during the physical action, in a real world, onto a user associated with the avatar.

In accordance with another aspect of the disclosure, a system for enabling a physical action experience from a virtual world is provided. The system includes a VR module and a control unit. The VR module is configured to detect an interaction between an avatar and one or more virtual objects or between one or more avatars in the virtual world. The VR module is configured to recognize that the interaction includes a physical action. The VR module is configured to measure a magnitude of the physical action. The VR module is configured to activate a device, in a real world, based on the measured magnitude of the physical action. The control unit of the device in the real world is configured to receive the measured magnitude of the physical action from the VR module. The control unit is configured to emulate the physical action and the magnitude exerted during the physical action, in the real world, onto a user associated with the avatar.

In accordance with another aspect of the disclosure, a wearable device for enabling a physical action experience from a virtual world is provided. The wearable device includes a wearable body device wearable by a user on a specified body portion of the user, a storage for storing a plurality of nano-magnetic particles, a pump operable for transferring the plurality of nano-magnetic particles from the storage to the wearable body device and vice-versa, and a controller communicatively coupled to virtual reality (VR) circuitry, wherein the controller is configured to receive information indicative of a magnitude of the physical action exerted onto the user associated with an avatar in the virtual world, control the pump to transfer a specified quantity of nano-magnetic particles proportionate to the magnitude of the physical action to the wearable body unit for allowing the user to feel an absolute weight of at least one virtual object in a real world.

In accordance with another aspect of the disclosure, a wearable device for experiencing physical actions in a virtual world is provided. The wearable device includes a wearable body unit that is wearable by a user on a specified body portion of the user, a plurality of compartments which are provided in the wearable body unit, and a control unit. The compartments are positioned to overlap with key points of the specified body portion of the user on which the wearable device is worn. The control unit is configured to transfer a specified quantity of nano-magnetic particles into selected one or more compartments. The specified quantity of nano-magnetic particles which are transferred into each compartment exerts a magnitude of physical action on the key points of the specified body portion of the user in a real world equivalent to the magnitude of physical action experienced by an avatar associated with the user in the virtual world.

In accordance with another aspect of the disclosure, one or more non-transitory computer-readable storage media storing one or more computer programs including computer-executable instructions that, when executed by at least one processor of a wearable device individually or collectively, the wearable device comprising communication circuitry, the executed instructions cause the wearable device to perform operations are provided. The operations include detecting an interaction between an avatar and one or more virtual objects or between one or more avatars in a virtual world, recognizing that the interaction includes a physical action, measuring a magnitude of the physical action, and activating the wearable device for emulating the physical action and the magnitude of the physical action, in a real world, onto a user associated with the avatar.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example block representation indicating user's experience in a virtual session while holding a virtual object, according to the related art;

FIG. 2 illustrates a system for enabling a physical action experience from a virtual world, according to an embodiment of the disclosure;

FIG. 3 illustrates a user wearing a wearable device, according to an embodiment of the disclosure;

FIG. 4 illustrates a perspective view of a storage unit, according to an embodiment of the disclosure;

FIG. 5 illustrates a perspective view of a storage unit indicating a slicing point and a calculated height, according to an embodiment of the disclosure;

FIG. 6A illustrates a schematic view of an electromagnetic track with a forward movement of a nano-magnetic particles, according to an embodiment of the disclosure;

FIG. 6B illustrates a schematic view of an electromagnetic track with a backward movement of a nano-magnetic particles, according to an embodiment of the disclosure;

FIG. 7 illustrates a schematic view of a wearable body unit, according to an embodiment of the disclosure;

FIG. 8 illustrates a schematic view of a user hand holding a virtual object in a virtual world and a user hand in a real world indicating a nano-magnetic particles accumulated region, according to an embodiment of the disclosure;

FIG. 9A illustrates a scenario of user's avatar hand in a metaverse environment with a center of mass (COM) calculation, according to an embodiment of the disclosure;

FIG. 9B illustrates a user hand in a real world corresponding to a scenario in FIG. 9A, according to an embodiment of the disclosure;

FIG. 10A illustrates another scenario of user's avatar hand in a metaverse environment with change in orientation of a virtual object, according to an embodiment of the disclosure;

FIG. 10B illustrates a user hand in a real world corresponding to a scenario in FIG. 10A, according to an embodiment of the disclosure;

FIG. 11 illustrates mapping a virtual hand of a user avatar to a hand glove using a three dimensional (3D) rigging method, according to an embodiment of the disclosure;

FIG. 12 illustrates a system architecture and flow of the processor, according to an embodiment of the disclosure;

FIG. 13 illustrates a block representation of a processor controlling components, according to an embodiment of the disclosure;

FIG. 14 illustrates a system flow representation of an activation module, according to an embodiment of the disclosure;

FIG. 15 illustrates a flow representation of a mapping module, according to an embodiment of the disclosure;

FIG. 16A illustrates a user's avatar hand in metaverse environment with COM in center of a virtual object, according to an embodiment of the disclosure;

FIG. 16B illustrates a user hand in a real world indicating a nano-magnetic particles accumulated region with COM in center of a virtual object, according to an embodiment of the disclosure;

FIG. 17A illustrates a user's avatar hand in metaverse environment with COM towards right of a virtual object, according to an embodiment of the disclosure;

FIG. 17B illustrates a user hand in a real world indicating a nano-magnetic particles accumulated region with COM towards right of a virtual object, according to an embodiment of the disclosure;

FIG. 18 illustrates a method for enabling a physical action experience in a virtual world, according to an embodiment of the disclosure;

FIG. 19 illustrates a method of emulating a physical action and a magnitude exerted during the physical action in a real world, according to an embodiment of the disclosure;

FIG. 20 illustrates a method for changing distribution of a nano-magnetic particles based on movement of a virtual object in a user's avatar hand, according to an embodiment of the disclosure;

FIGS. 21A and 21B illustrate a use case of gaming in metaverse, according to various embodiments of the disclosure;

FIGS. 22A and 22B illustrate a use case of sport training or gym in metaverse, according to various embodiments of the disclosure;

FIG. 23 illustrates a use case of doctor treating patients in metaverse, according to an embodiment of the disclosure;

FIG. 24 illustrates a use case of shopping in metaverse, according to according to an embodiment of the disclosure; and

FIGS. 25A, 25B, and 25C illustrate a use case of people interacting in metaverse, according to various embodiments of the disclosure.

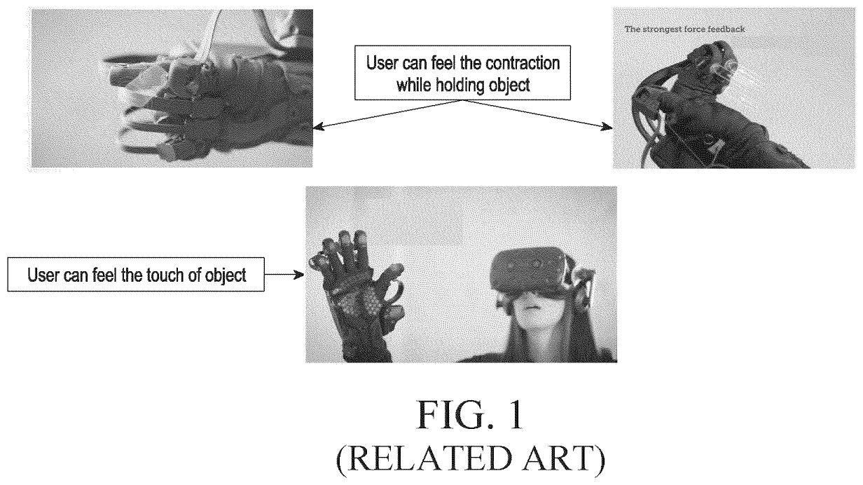

Throughout the drawings, it should be noted that like reference numbers are used to depict the same or similar elements, features, and structures.

### DETAILED DESCRIPTION

The following description with reference to accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the operations required for understanding of aspects of the embodiments as disclosed herein. Furthermore, in terms of the construction of the device, one or more components of the device may have been represented in the drawings by conventional symbols, and the drawings may show only those specific details that are pertinent to understanding the embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps/operations is for the purposes of this description and should not be construed as sequential ordering/placement/occurrence unless specified otherwise.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

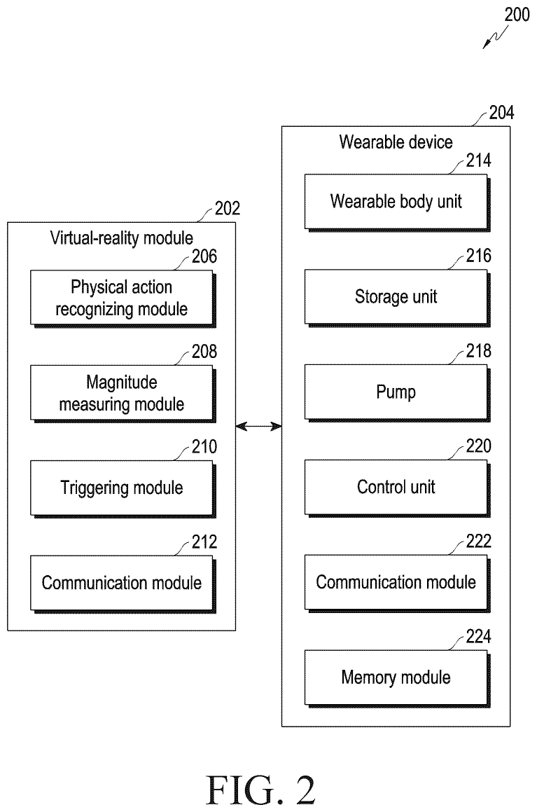

The embodiments herein provide systems and methods for enabling a user to feel a physical action experience of one or more virtual objects in a virtual world. Referring now to the drawings, and more particularly to FIGS. 2 to 5, 6A, 6B, 7, 8, 9A, 9B, 10A, 10B, 11 to 15, 16A, 16B, 17A, 17B, 18 to 20, 21A, 21B, 22A, 22B, 23, 24, and 25A to 25C, where similar reference characters denote corresponding features consistently throughout the figures, there are shown various embodiments.

FIG. 2 illustrates a system for enabling a physical action experience from a virtual world (e.g., metaverse, augmented reality (AR), and extended reality (XR)) according to an embodiment of the disclosure.

Referring to FIG. 2, the physical action can be, but not limited to a physical force, a pressure and a weight. a system 200 comprises a virtual-reality (VR) module 202 and a wearable device 204.

In an embodiment, the VR module 202 may be configured to estimate a physical action experienced by an avatar of a user on a virtual object. The VR module 202 may comprise a physical action recognizing module 206, a magnitude measuring module 208, a triggering module 210, and a communication module 212.

In an embodiment, the physical action recognizing module 206 may detect an interaction between an avatar and one or more virtual objects in the virtual world. In an embodiment, the physical action recognizing module 206 may detect an interaction between one or more avatars in the virtual world. The physical action recognizing module 206 may recognize that the interaction includes a physical action. In an embodiment, the interaction may include the physical action by the avatar on at least one virtual object in the virtual world. For example, the interaction may include the physical action between a first avatar and a second avatar.

In an embodiment, the magnitude measuring module 208 may measure a magnitude of the physical action. In an embodiment, the magnitude of the physical action may be an absolute weight of the virtual object. For example, the magnitude of the physical action between the first avatar and the second avatar may be applied onto a first user and a second user in the real world.

In an embodiment, the triggering module 210 may trigger a device, in a real world, based on the measured magnitude of the physical action. In an embodiment, the triggering module 210 may trigger the wearable device 204.

In an embodiment, the communication module 212 may enable communication between the VR module 202 and the wearable device 204.

In an embodiment, the wearable device 204 may emulate the physical action and the magnitude exerted during the physical action, in a real world, onto a user associated with the avatar. Emulation is the use of an application program or device to imitate the behavior of another program or device. The wearable device 204 may comprise a wearable body unit 214, a storage unit 216, a pump 218, a control unit 220, a communication module 222, and memory module 224.

In an embodiment, the wearable body unit 214 may be wearable by the user. The wearable body unit 214 may be wearable on a specified body portion of the user. In an embodiment, the storage unit 216 may be configured for storing a plurality of nano-magnetic particles. In an embodiment, the pump 218 may be operable for transferring the nano-magnetic particles from the storage unit 216 to the wearable body unit 214 and vice-versa. In an embodiment, the control unit 220 may include one or more processors and be communicatively coupled to the VR module 202. The control unit 220 may be configured to receive information indicative of a magnitude of the physical action exerted onto the user associated with the avatar in the virtual world. The control unit 220 may receive the information from the triggering module 210 of the VR module 202. The control unit 220 may control the pump 218 to transfer a specified quantity of nano-magnetic particles proportionate to the magnitude of the physical action to the wearable body unit 214. This allows the user to feel the magnitude of the physical action (e.g., absolute weight) of at least one virtual object in the real world.

In an embodiment, the plurality of modules of the VR module 202 may communicate with the wearable device 204 via the communication module 212 and the communication module 222. The communication module 212 and the communication module 222 may be in the form of either a wired network or a wireless communication network module. The wireless communication network may comprise, but not limited to, global positioning system (GPS), global system for mobile communications (GSM), Wi-Fi, bluetooth low energy, near-field communication (NFC), and so on. The wireless communication may further comprise one or more of bluetooth, ZigBee, a short-range wireless communication (such as ultra-wideband (UWB)), and a medium-range wireless communication (such as Wi-Fi) or a long-range wireless communication (such as third generation (3G)/fourth generation (4G)/fifth generation (5G)/sixth generation (6G) and non-third generation partnership project (3GPP) technologies or worldwide interoperability for microwave access (WiMAX)), according to the usage environment.

In an embodiment, the memory module 224 may comprise one or more volatile and non-volatile memory components which are capable of storing data and instructions of the components or modules of the wearable device 204 to be executed. Examples of the memory module 224 may be, but not limited to, not and (NAND), embedded multimedia card (eMMC), secure digital (SD) cards, universal serial bus (USB), serial advanced technology attachment (SATA), solid-state drive (SSD), and so on. The memory module 224 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory module 224 may, in some examples, be considered a non-transitory storage medium. The term “non-transitory” may indicate that the storage medium is not embodied in a carrier wave or a propagated signal. However, the term “non-transitory” should not be interpreted to mean that the memory module 224 is non-movable. In certain examples, a non-transitory storage medium may store data that can, over time, change (e.g., in random access memory (RAM) or cache).

FIG. 2 shows example modules of the VR module 202 and the wearable device 204 respectively, but it is to be understood that other embodiments are not limited thereon. In an embodiments, the VR module 202 and the wearable device 204 may include less or more number of modules. Further, the labels or names of the modules are used only for illustrative purpose and does not limit the scope of the disclosure. One or more modules may be combined together to perform same or substantially similar function in the VR module 202 and the wearable device 204.

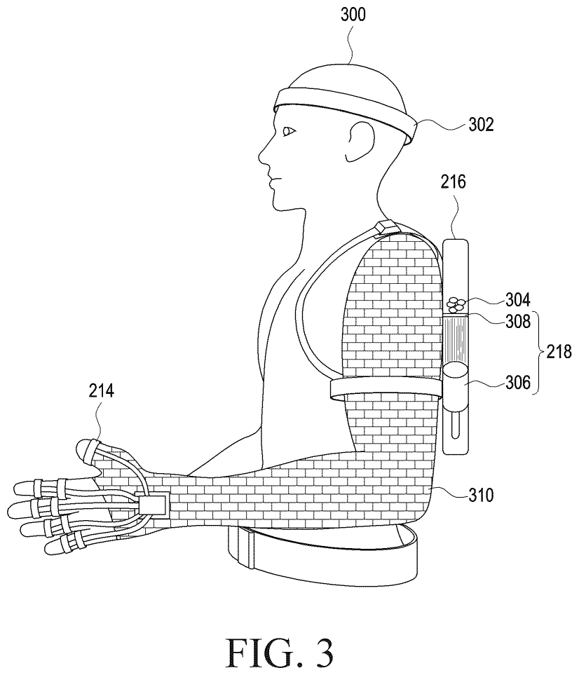

FIG. 3 illustrates a user wearing the wearable device according to an embodiment of the disclosure.

Referring to FIG. 3, a user 300 is worn with a headband. The headband may be equipped with a processor 302. The processor 302 may include the control unit 220 for emulating the physical action and the magnitude exerted during the physical action, in the real world, onto a user associated with the avatar. As depicted, the user 300 may wear a hand wearable object that includes other components of the wearable device 204.

In an embodiment, the processor 302 comprising the control unit 220 may be included in the hand wearable object as a single device. In an embodiment, the processor 302 may be included in other wearable object other than headband, such as bracelet, smart watch, and so on.

The components of the wearable device 204 indicated on the hand wearable object may include the wearable body unit 214, the storage unit 216, the pump 218, and an electromagnetic track 310. In an embodiment, the wearable body unit 214 depicted may be an electro-magnetic hand glove.

In an embodiment, the storage unit 216 may enclose a plurality of nano-magnetic particles 304 and the pump 218. In an embodiment, the pump 218 may comprise a piston 306 and a slicer 308 for transferring a specified quantity of nano-magnetic particles 304 from the storage unit 216. The piston 306 and the slicer 308 may be arranged inside the storage unit 216. The control unit 220 of the processor 302 may control the piston 306 for moving the nano-magnetic particles 304 upwards towards the slicer 308 and above a slicing point, based on information received from the triggering module 210 of the VR module 202. In an embodiment, the control unit 220 may control the slicer 308 for separating the specified quantity of nano-magnetic particles 304 from the plurality of nano-magnetic particles 304. The slicer 308 may be further controlled by the control unit 220 for forwarding the separated specified quantity of nano-magnetic particles 304 to the electromagnetic track 310. The nano-magnetic particles 304 may dynamically flow through the electromagnetic track 310 to different parts of the wearable body unit 214 (electro-magnetic hand glove). The accumulated nano-magnetic particles 304 in the wearable body unit 214 allow the user 300 to feel the weight of the virtual object in the real world.

For example, a nano-magnetic particle may be a sub-micrometric system that presents spontaneous magnetic order at zero applied magnetic field. Canonical examples of the nano-magnetic particle may be grains of ferromagnetic metals (iron, cobalt, nickel) and single-molecule magnets. In neutral state, the nano-magnetic particles 304 may be stored in pouches attached to body parts like the back, where the weight does not create much hindrance while movements and is not bothersome. A change in the polarity of the magnetic track may allow the flow of the nano-magnetic particles 304.

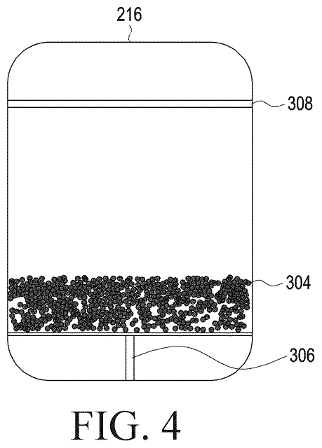

FIG. 4 illustrates a perspective view of a storage unit according to an embodiment of the disclosure.

Referring to FIG. 4, the nano-magnetic particles 304 may be uniformly distributed in the storage unit 216. When the processor 302 activates the piston 306 for upward and downward movement of the nano-magnetic particles 304 inside the storage unit 216, the piston 306 may move required quantity of the nano-magnetic particles 304 in an upward motion towards the slicer 308, based on weight of the virtual object received from the VR module 202. The slicer 308 may separate the required quantity of the nano-magnetic particles 304 from the rest. The separated nano-magnetic particles 304 may be transferred to the electromagnetic track 310 which may define the motion of the nano-magnetic particles 304 to and from the wearable body unit 214 (electro-magnetic hand glove).

In an embodiment, the storage unit 216 may be cylindrical in shape. The amount of nano-magnetic particles 304 (with weight (w) equivalent to the weight of the virtual object) required may be separated by the slicer 308 by calculating quantity of the nano-magnetic particles 304 to be sliced. The calculation operations are as follows:

Volume (V) of the nano-magnetic particles 304 is calculated using the known mass (m) [weight (w)/gravitation force] simply by dividing mass by nao-magnetic density (φ: V=m/ρ

Height above a slicing point is calculated using the formula,

$$h = \frac{V}{π {r}^{2}}$$

Where,
h=required height
V=volume calculated in operation 1
r=radius of storage chamber

Piston 306 is moved up in such a manner so that the nano-magnetic particles 304 are above the slicing point by the height (h) calculated in operation 2

The required nano-magnetic particles 304 are separated via the slicer 308 and the nano-magnetic particles 304 above the slicer 308 will flow forward to the electromagnetic track 310.

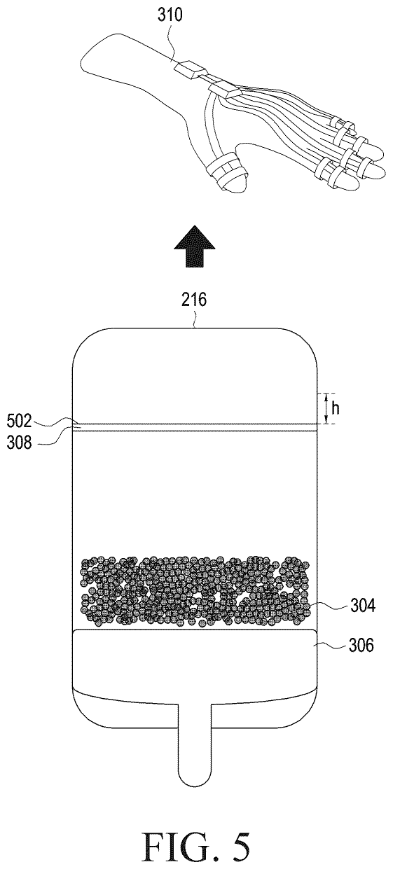

FIG. 5 illustrates a perspective view of a storage unit indicating the slicing point and the calculated height according to an embodiment of the disclosure.

Referring to FIG. 5, the calculated height (h) above a slicing point 502 may be configured for separating the nano-magnetic particles 304 by the height above the slicer 308. The separated nano-magnetic particles 304 above the slicing point 502 may be forwarded to the electromagnetic track 310.

In an embodiment, the electromagnetic track 310 may be designed in a hollow structure with an outer layer and an inner layer. The outer layer and the inner layer may be each arranged with an array of electromagnets to produce a desired magnetic acceleration of the specified quantity of nano-magnetic particles 304 to flow in a forward direction or in a backward direction. The desired magnetic acceleration may be produced by changing polarity of the array of electromagnets to control motion of the nano-magnetic particles 304.

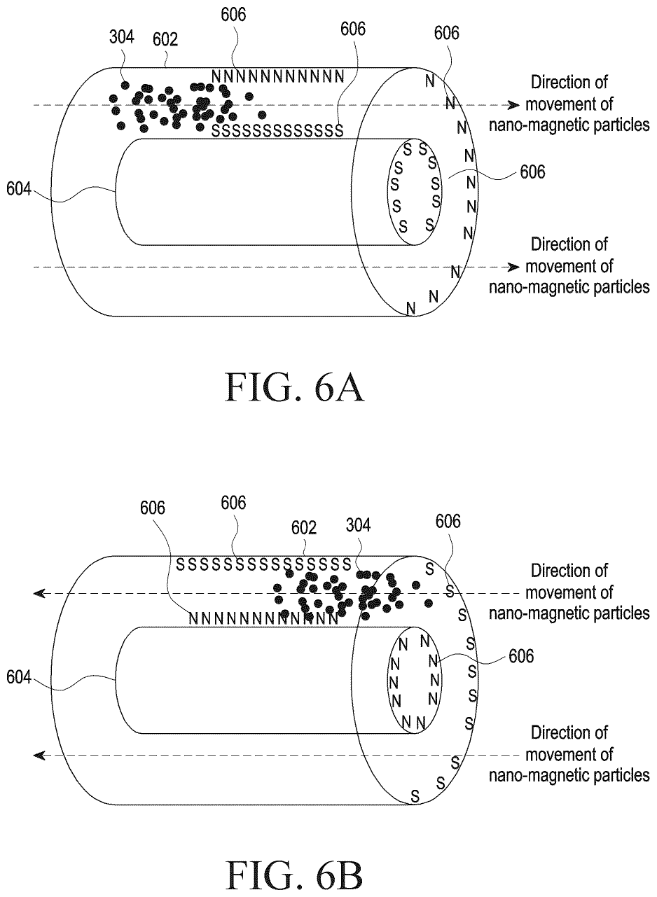

FIG. 6A illustrates a schematic view of an electromagnetic track with a forward movement of the nano-magnetic particles according to an embodiment of the disclosure.

FIG. 6B illustrates a schematic view of an electromagnetic track with a backward movement of the nano-magnetic particles according to an embodiment of the disclosure.

Referring to FIGS. 6A and 6B, the electromagnetic track 310 may have a hollow structure with an outer layer 602 and an inner layer 604. The hollow structure with the outer layer 602 and the inner layer 604 may be wrapped around an arm of the user 300. The nano-magnetic particles 304 may be of spherical shape. An array of the electromagnets 606 may be arranged in the outer layer 602 and the inner layer 604 as shown to produce the desired magnetic acceleration of magnets in forward or backward direction. The current flow across the electromagnets 606 may allow the user 300 to change the polarity on demand to control the motion of the nano-magnetic particles 304.

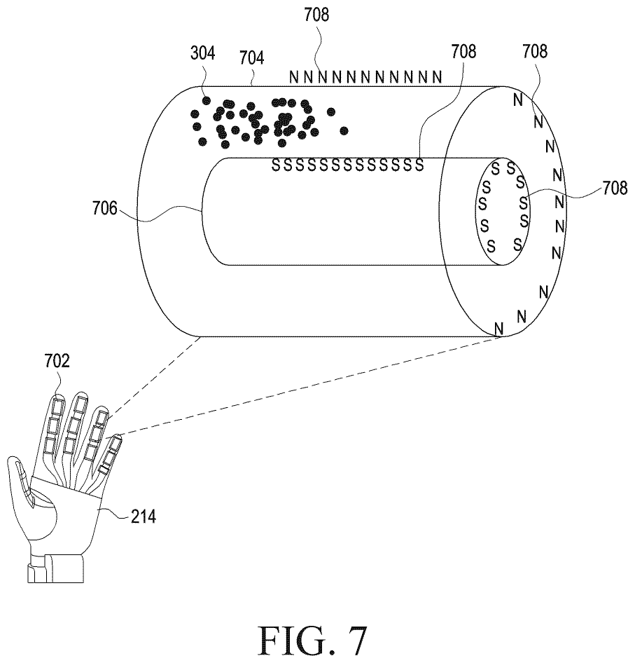

FIG. 7 illustrates a schematic view of a wearable body unit (electro-magnetic hand glove) according to an embodiment of the disclosure.

Referring to FIG. 7, the nano-magnetic particles 304 may be distributed from the electromagnetic track 310 to the wearable body unit 214. In an embodiment, the wearable body unit 214 may be designed with a plurality of compartments 702. The compartments 702 may be provided in the wearable body unit 214 and are positioned to overlap with key points of the specified body portion of the user 300 on which the wearable device 204 may be worn. Each compartment 702 may be designed in a hollow structure with an outer layer 704 and an inner layer 706.

The outer layer 704 and the inner layer 706 of each compartment 702 may be arranged with one or more programmable electromagnets 708 which allow the nano-magnetic particles 304 to attach to the user hand. For example, the programmable electromagnets 708 which are arranged on the outer layers 704 of selected compartments 702 may be deactivated to distribute the nano-magnetic particles 304 from the electromagnetic track 310 to attach to the inner layers 706 of the selected compartments 702 of the wearable body unit 214 worn on the specified body portion of the user 300.

The programmable electromagnets 708 on the outer layer 704 may be deactivated by the processor 302. In an embodiment, the quantity of thee nano-magnetic particles 304 to be attached may be controlled by the processor 302 by varying the strength of the programmable electromagnets 708. The more the weight of the virtual object, the more the nano-magnetic particles 304 may be attached to the wearable body unit 214 and vice versa. The nano-magnetic particles 304 may be distributed across the electro-magnetic hand glove according to the contact points calculated.

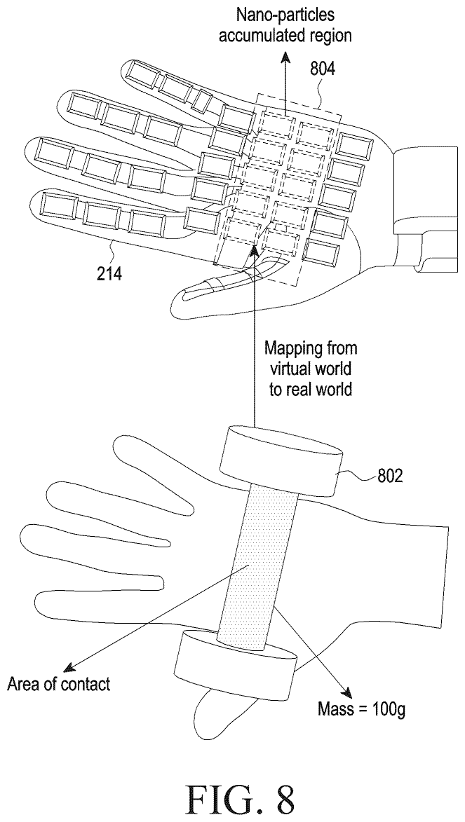

FIG. 8 illustrates a schematic view of a user hand holding a virtual object 802 in a virtual world and a user hand in a real world indicating a nano-magnetic particles 304 accumulated region 804 according to an embodiment of the disclosure.

In an embodiment, the processor 302 may transfer the required quantity of the nano-magnetic particles 304 from the storage unit 216 to the electromagnetic track 310. For example, if weight of the virtual object 802 is 100 g, 100 g of nano-magnetic particles 304 may be transferred to the electromagnetic track 310. The transferred nano-magnetic particles 304 may be distributed to user's hand in real world by mapping the area of contact of the virtual object 802 in user's avatar hand in the virtual world to the real world user's hand.

The nano-magnetic particles 304 accumulated in the region 804 shown in the FIG. 8b can have mass of their own. This mass is equivalent to the mass of the virtual object 802 in the virtual world held by the avatar in the corresponding region. Gravitational force act on these magnets which allow the person to feel the absolute weight in the real world. For example, if a dumbbell of mass 100 g (weight 1N) is held by the avatar as shown in FIG. 8, the region 804 shown in FIG. 8 has nano-magnetic particles 304 of mass 100 g. When gravitation force of ~10N/kg is applied, the user 300 may feel the absolute weight same as weight held by avatar in the virtual world.

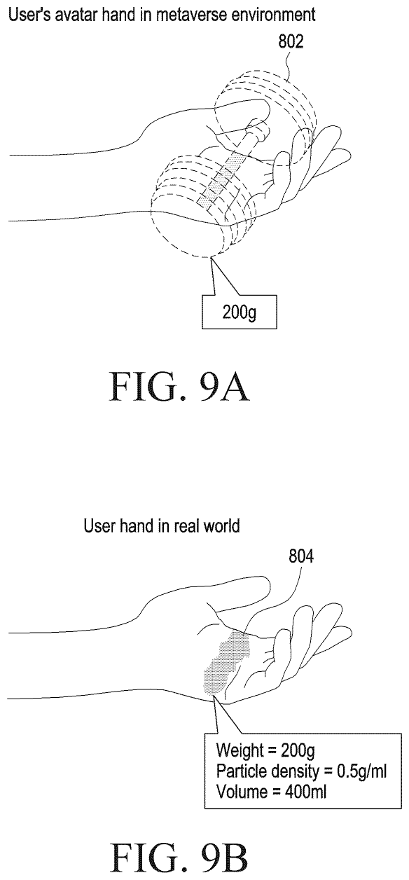

FIGS. 9A and 9B illustrate a comparison of a user's hand in real world and metaverse environment according to various embodiments of the disclosure.

Referring to FIG. 9A, a scenario of user's avatar hand in the metaverse environment with center of mass (COM) calculation is illustrated.

Referring to FIG. 9B, user hand in the real world corresponding to the scenario in FIG. 9A is illustrated. When the user 300 picks up the virtual object 802 (dumbbell) in the metaverse environment as depicted in FIG. 9A, the COM for gravitational force may be calculated according to hand's frame of reference, and weight of the virtual object 802 is calculated, for example say 200 gms. Dimension (area) of the virtual object 802 which is projected on user's hand may be measured to calculate the corresponding pressure. For example, weight in that particular region 804 may be calculated as 200 g, particle density as 0.5 g/ml, and volume as 400 ml, based on COM and weight of the virtual object 802.

The processor 302 may activate the storage unit 216 for appropriate quantity of the nano-magnetic particles 304 to flow through it, and calculate the appropriate quantity of the nano-magnetic particles 304 using the calculated particle density, volume and weight at that particular region 804. Further, the processor 302 may enable the nano-magnetic particles 304 to distribute across that particular region 804 of hand in the real world.

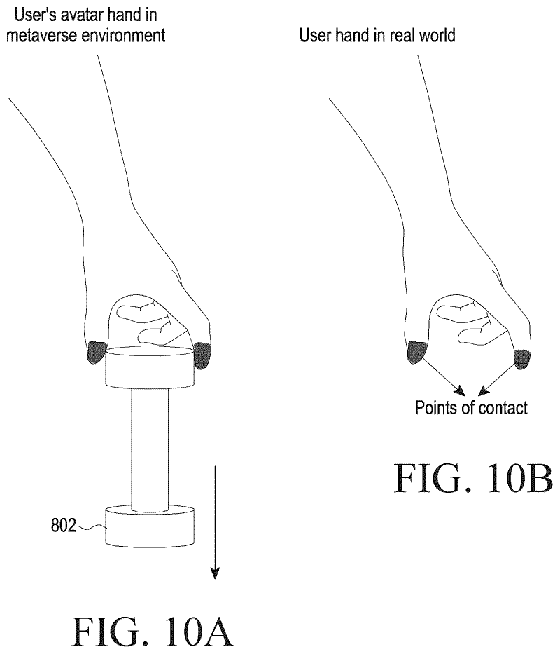

FIG. 10A illustrates another scenario of user's avatar hand in a metaverse environment with change in orientation of a virtual object according to an embodiment of the disclosure.

FIG. 10B illustrates user hand in a real world corresponding to a scenario in FIG. 10A according to an embodiment of the disclosure.

Referring to FIGS. 10A and 10B, in case of the orientation of the virtual object 802 changes as depicted in the FIG. 10A, the COM with respect to palm's frame of reference is calculated again. Further, the nano-magnetic particles 304 may be distributed to points of contact based on the calculated COM.

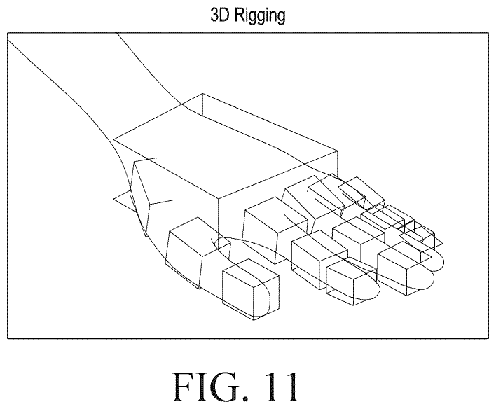

FIG. 11 illustrates mapping a virtual hand of the user avatar to a hand glove using a three dimensional (3D) rigging method according to an embodiment of the disclosure.

Referring to FIG. 11, the control unit 220 of the processor 302 may utilize the 3D rigging method for mapping the data of the calculated COM, the calculated contact point, and the measured pressure to the specified body portion of the user in the real world. The contact point may be calculated using geometry and COM of the virtual object 802 with respect to the specified body portion of the user. When the virtual object 802 moves in the virtual world, the contact point with respect to the specified body portion of the user may change and the control unit 220 accordingly may change the strength and polarity of one or more programmable electromagnets 708 to distribute the nano-magnetic particles 304 across the wearable body unit 214 (electro-magnetic hand glove).

For example, the 3D rigging method is the process of creating virtual bones, joints, muscles, and so on that allows models to move. These virtual bones, joints, muscles, and so on can be transformed using digital animation software, for example their position, rotation, and scale may be changed. The process of 3D rigging may be used to map the virtual hand to user glove in the real world. First, different bones and joints (rigs) in the virtual hand are identified, and the programmable electromagnets 708 are arranged in the hand glove in such a manner that the programmable electromagnets 708 mimic the regions of the bones and joints (rigs).

When user's avatar lifts the virtual object 802 in the virtual world, contact points on rigs are calculated, and same effect can be mapped to the hand glove. The control unit 220 of the processor 302 may trigger those areas in the hand glove according to the calculated contact points and the nano-magnetic particles 304 get attached to the triggered areas in the hand glove.

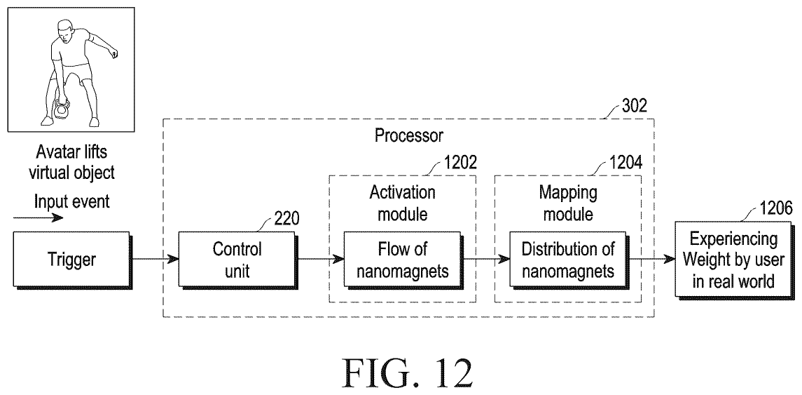

FIG. 12 illustrates a system architecture and flow of a processor according to an embodiment of the disclosure.

Referring to FIG. 12, the processor 302 may comprise the control unit 220, an activation module 1202, and a mapping module 1204. The control unit 220 of the wearable device 204 may be triggered, when an input event of lifting a virtual object 802 is performed by an avatar.

In an embodiment, the control unit 220 may calculate a COM of the virtual object 802 lifted by the avatar in the virtual world. The control unit 220 may calculate at least one contact point of the virtual object 802 projected on a specified body portion of the user. The control unit 220 may measure a pressure applied at the contact point. The control unit 220 may send signal to the activation module 1202 to activate the storage unit 216 and the electromagnetic track 310, based on the calculated COM, contact point and pressure, to control the flow of the nano-magnetic particles 304. The control unit 220 may send signal to the mapping module 1204 to control distribution of the nano-magnetic particles 304 in the wearable body unit 214.

In an embodiment, the activation module 1202 may activate the piston 306 and the slicer 308 for separating a specified quantity of nano-magnetic particles 304 based on the calculated COM, contact point and pressure, and forwarding the separated specified quantity of nano-magnetic particles 304 to the electromagnetic track 310. The activation module 1202 may activate the array of the electromagnets 606 that is arranged in the electromagnetic track 310 to control the motion of the nano-magnetic particles 304 towards the wearable body unit 214.

In an embodiment, the mapping module 1204 may map data of the calculated COM, the calculated contact point, and the measured pressure, to the specified body portion of the user in the real world. The mapping module 1204 may select desired compartments 702 of the wearable body unit 214 based on the mapped data. The mapping module 1204 may activate one or more programmable electromagnets 708 of the selected compartments 702 to distribute the specified quantity of the nano-magnetic particles 304 across the inner layers 706 of the selected compartments 702 of the wearable body unit 214 according to the mapped data and the calculated contact point of the virtual object 802 to attach the nano-magnetic particles 304 onto the specified body portion of the user in the real world. The specified quantity of nano-magnetic particles 304 transferred into each compartment 702 may exert a magnitude of physical action on the key points of the specified body portion of the user in a real world equivalent to the magnitude of physical action experienced by an avatar associated with the user in the virtual world.

Therefore, an absolute weight may be experienced by the user in the real world, as depicted at 1206.

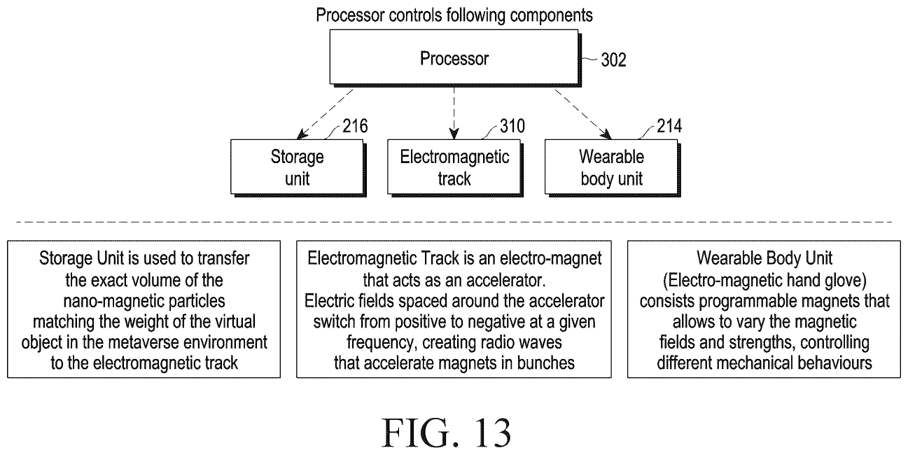

FIG. 13 illustrates a block representation of a processor controlling components according to an embodiment of the disclosure.

Referring to FIG. 13, the processor 302 may control the storage unit 216, the electromagnetic track 310, and the wearable body unit 214 (electro-magnetic hand glove). The storage unit 216 may be used to transfer an exact volume of the nano-magnetic particles 304 matching the weight of the virtual object 802 in the metaverse environment to the electromagnetic track 310. The electromagnetic track 310 may be an electro-magnet that acts as an accelerator. Electric fields spaced around the accelerator switch from positive to negative at a given frequency, creating radio may wave that accelerate magnets in bunches. The wearable body unit 214 may consist of programmable electromagnets 708 that allow varying the magnetic fields and strengths, further controlling different mechanical behaviors such as attaching the nano-magnetic particles 304 onto the specified body portion of the user.

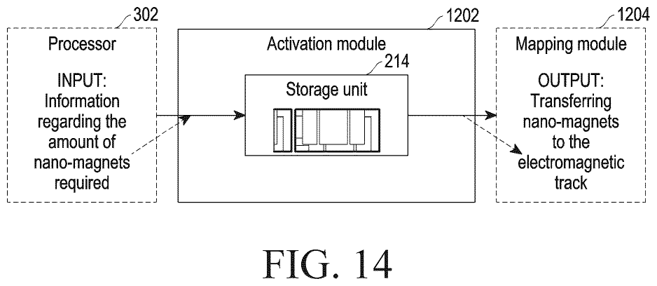

FIG. 14 illustrates a system flow representation of an activation module according to an embodiment of the disclosure.

Referring to FIG. 14, the activation module 1202 may receive input from the processor 302. The input includes information regarding required amount of the nano-magnetic particles 304. The activation module 1202 may activate the storage unit 216 based on the information received from the processor 302. The storage unit 216 may collect the nano-magnetic particles 304 from the storage unit 216 to transfer them to the electromagnetic track 310. The mapping module 1204 may activate the programmable electromagnets 708 of the wearable body unit 214, after receiving the nano-magnetic particles 304 from the electromagnetic track 310.

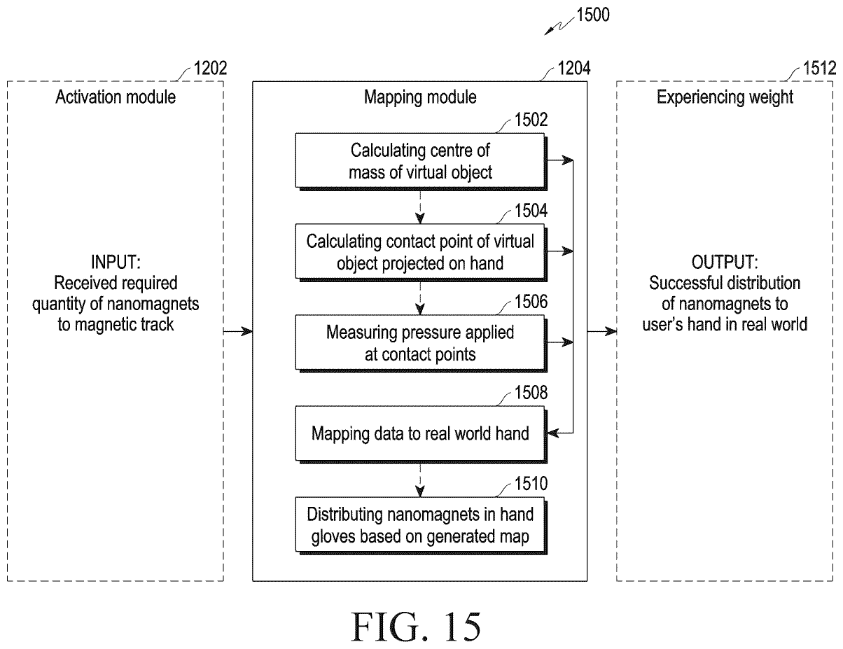

FIG. 15 illustrates a flow representation of a mapping module according to an embodiment of the disclosure.

Referring to FIG. 15, the activation module 1202 upon receiving required quantity of the nano-magnetic particles 304 as input, may transfer the nano-magnetic particles 304 to the electromagnetic track 310. The mapping module 1204 may comprise a flow method 1500. The method 1500 may comprise calculating, by the mapping module 1204, a COM of the virtual object 802, at operation 1502. The method 1500 comprises calculating, by the mapping module 1204, at least one contact point of the virtual object 802 projected on the specified body portion of the user (user hand), at operation 1504. The method 1500 comprises measuring, by the mapping module 1204, pressure applied at contact points, at operation 1506.

The method 1500 may comprise mapping, by the mapping module 1204, data of the calculated COM, the calculated contact point, and the measured pressure to the specified body portion of the user (user hand) in the real world, at operation 1508. The method 1500 may comprise distributing, by the mapping module 1204, the nano-magnetic particles 304 in the wearable body unit 214 (electro-magnetic hand glove) based on generated map, at operation 1510. The mapping module 1204 may distribute a specified quantity of the nano-magnetic particles 304 across the inner layers 706 of the selected one or more compartments 702 of the wearable body unit 214 according to the mapped data and the calculated contact point of the virtual object 802 to attach the nano-magnetic particles 304 onto the specified body portion of the user in the real world. Therefore, the user may experience weight corresponding to the virtual object 802 in the virtual world by successful distribution of the nano-magnetic particles 304 to the user's hand in the real world, at operation 1512.

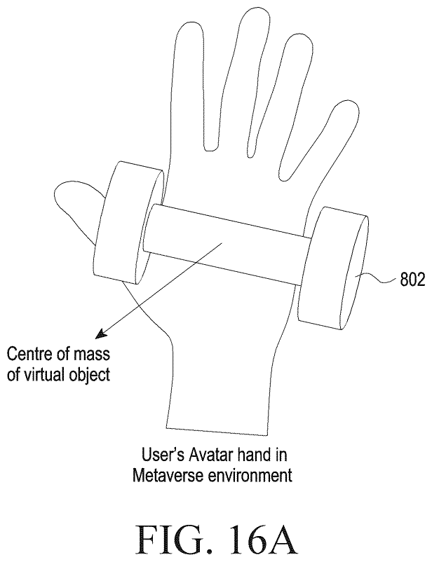

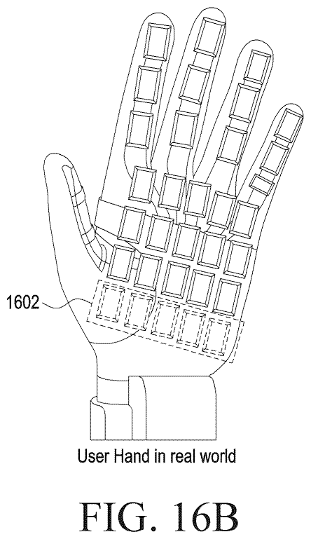

FIGS. 16A and 16B illustrate a scenario of change in distribution of nano-magnetic particles with COM in center of a virtual object according to various embodiments of the disclosure.

Referring to FIG. 16A, a user's avatar hand in metaverse environment with COM in center of the virtual object 802 is illustrated. Referring to FIG. 16B, a user hand in the real world indicating a nano-magnetic particles accumulated region 1602 with COM in center of the virtual object 802 is illustrated. When the virtual object 802 moves in the user's avatar hand in the virtual world, distribution of the nano-magnetic particles 304 may change in the electro-magnetic hand glove, as indicated in the nano-magnetic particles accumulated region 1602 which is depicted in the FIG. 16B.

The contact points of the virtual object 802 may be calculated using geometry of the virtual object 802 and COM with respect to user's hand. As the virtual object 802 moves, its COM may move and contact point may change accordingly. The processor 302 may change the strength and polarity of the programmable electromagnets 708 accordingly, so that the nano-magnetic particles 304 move and distribute themselves allowing the user to feel the actual weight.

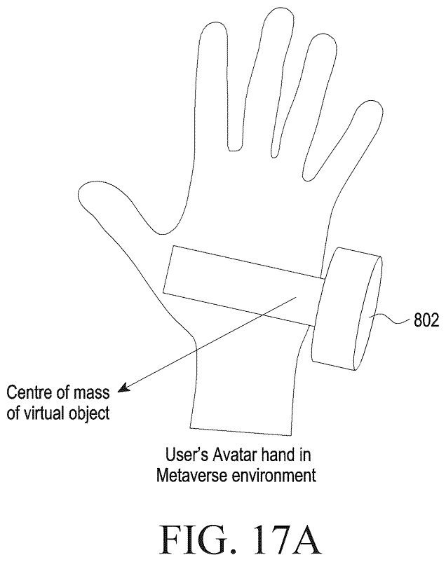

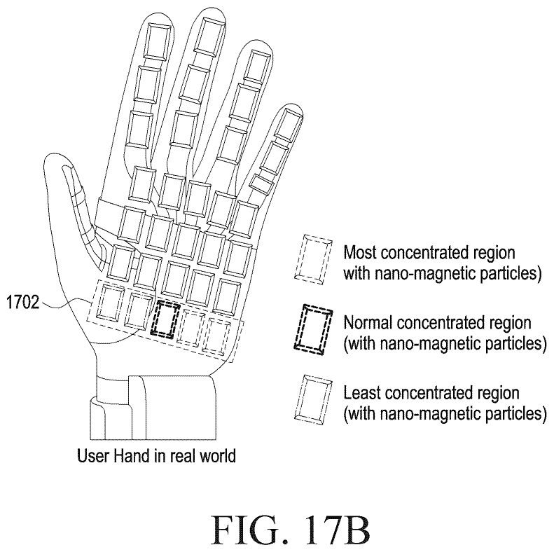

FIGS. 17A and 17B illustrate a scenario of change in distribution of nano-magnetic particles with COM towards right of a virtual object according to various embodiments of the disclosure.

Referring to FIG. 17A, a user's avatar hand in metaverse environment with COM towards right of the virtual object 802 is illustrated. Referring to FIG. 17B, a user hand in the real world indicating a nano-magnetic particles accumulated region 1702 with COM towards right of the virtual object 802 is illustrated. When the virtual object 802 moves in the user's avatar hand in the virtual world, distribution of the nano-magnetic particles 304 may change in the electro-magnetic hand glove, as indicated in the nano-magnetic particles accumulated region 1702 which is depicted in the FIG. 17B.

The geometry and COM of the virtual object 802 may allow obtaining the actual pressure applied on the contact point by a certain portion of object. If the weight is distributed unevenly, the nano-magnetic particles 304 may be also distributed in the same manner providing a more realistic feel to user.

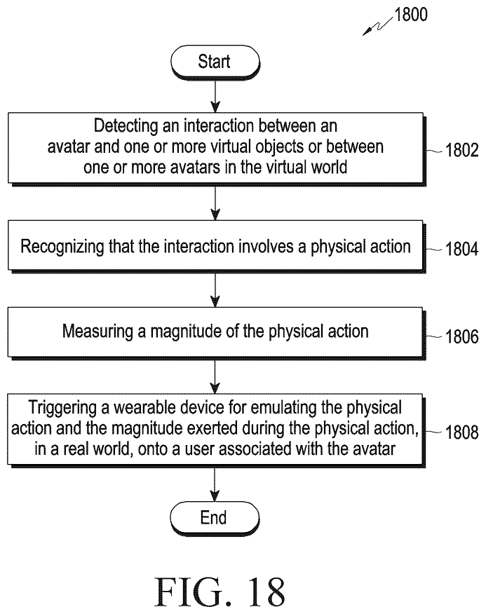

FIG. 18 illustrates a method for enabling a physical action experience in a virtual world according to an embodiment of the disclosure.

Referring to FIG. 18, a method 1800 may comprise detecting, by the VR module 202, an interaction between an avatar and one or more virtual objects or between one or more avatars in the virtual world, at operation 1802. The method 1800 may comprise recognizing, by the VR module 202, that the interaction includes a physical action, at operation 1804. The interaction may include the physical action by the avatar on at least one virtual object 802 in the virtual world. The physical action may comprise at least one of a physical force, a pressure and a weight. The method 1800 may comprise measuring, by the VR module 202, a magnitude of the physical action, at operation 1806. The method 1800 may comprise triggering, by the VR module 202, a wearable device 204 for emulating the physical action and the magnitude exerted during the physical action, in a real world, onto a user associated with the avatar, at operation 1808.

The various actions in method 1800 may be performed in the order presented, in a different order or simultaneously. Further, in some embodiments, some actions listed in FIG. 18 may be omitted.

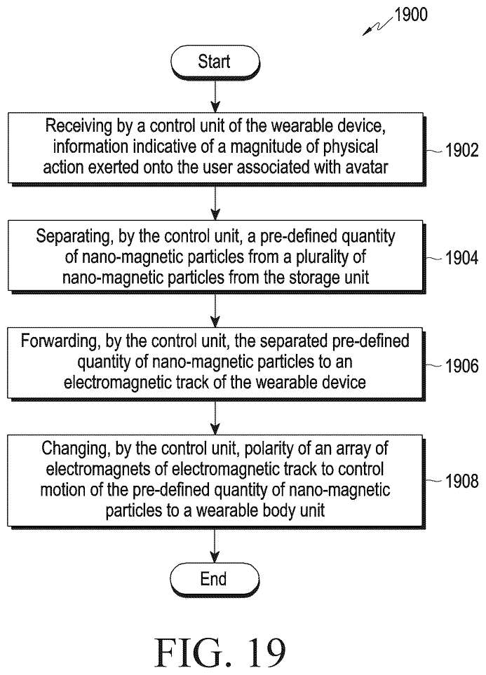

FIG. 19 illustrates a method of emulating a physical action and a magnitude exerted during a physical action in a real world according to an embodiment of the disclosure.

Referring to FIG. 19, a method 1900 may comprise receiving, by a control unit 220 of the wearable device 204, information indicative of the magnitude of the physical action exerted onto the user associated with the avatar, from the VR module 202, at operation 1902. The method 1900 may comprise separating, by the control unit 220, a specified quantity of nano-magnetic particles 304 from a plurality of nano-magnetic particles 304 from the storage unit 216, at operation 1904, by controlling the piston 306 and the slicer 308 of the storage unit 216.

The method 1900 may comprise forwarding, by the control unit 220, the separated specified quantity of nano-magnetic particles 304 to an electromagnetic track 310 of the wearable device 204, at operation 1906, by controlling the slicer 308 of the storage unit 216. The method 1900 may comprise changing, by the control unit 220, a polarity of an array of electromagnets 606 of the electromagnetic track 310 for producing a desired magnetic acceleration to control motion of the specified quantity of nano-magnetic particles 304 to the wearable body unit 214, at operation 1908. The control unit 220 may transfer the specified quantity of the nano-magnetic particles 304 proportionate to the magnitude of the physical action to the wearable body unit 214 of the wearable device 204. This may allow the user to feel the absolute weight of the virtual object 802 in the real world. The wearable body unit 214 (electro-magnetic hand glove) may be wearable by the user on a specified body portion of the user.

The various actions in method 1900 may be performed in the order presented, in a different order or simultaneously. Further, in some embodiments, some actions listed in FIG. 19 may be omitted.

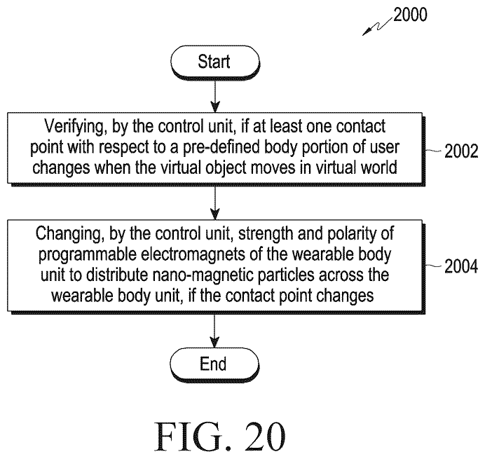

FIG. 20 illustrates a method for changing distribution of nano-magnetic particles based on movement of a virtual object in the user's avatar hand according to an embodiment of the disclosure.

Referring to FIG. 20, a method 2000 may comprise verifying, by the control unit 220, if at least one contact point with respect to the specified body portion of the user changes when the virtual object 802 moves in the virtual world, at operation 2002. The contact points of the virtual object 802 may be calculated using geometry of the virtual object 802 and COM with respect to user's hand. As the virtual object 802 moves, its COM may move and contact point may change accordingly. The method 2000 may comprise changing, by the control unit 220, accordingly the strength and polarity of one or more programmable electromagnets 708 of the wearable body unit 214 to distribute the nano-magnetic particles 304 across the wearable body unit 214, if the at least one contact point changes, at operation 2004.

The various actions in method 2000 may be performed in the order presented, in a different order or simultaneously. Further, in some embodiments, some actions listed in FIG. 20 may be omitted.

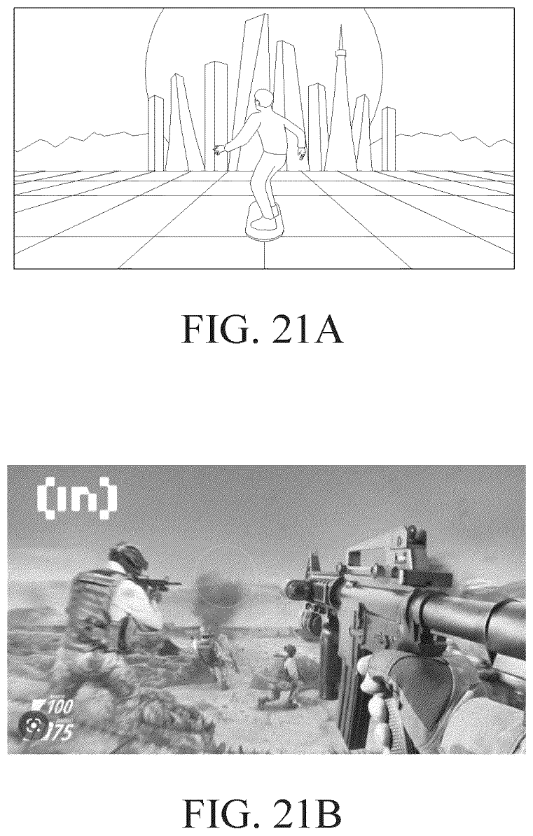

FIGS. 21A and 21B illustrate a use case of gaming in metaverse according to various embodiments of the disclosure.

Referring to FIGS. 21A and 21B, while playing games in the metaverse, the user may experience weight of the gaming objects which gives the user a better gaming experience. For example, while holding a gun in metaverse, the user can feel the exact weight of it.

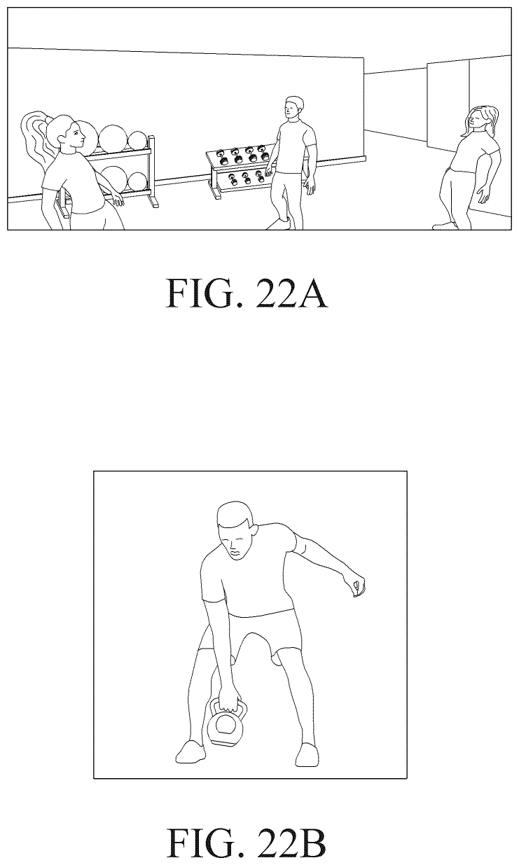

FIGS. 22A and 22B illustrate a use case of sport training or gym in metaverse according to various embodiments of the disclosure.

Referring to FIGS. 22A and 22B, extension of the system 200 (which allows flow of the nano-magnetic particles 304 to different parts of user's body) may also be used to train different regions of user's muscle eliminating the need of gym or sport arena.

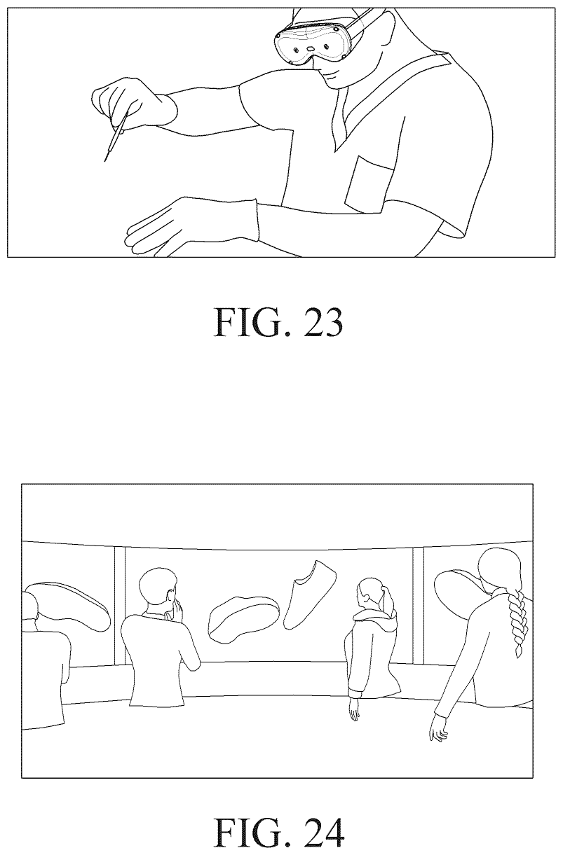

FIG. 23 illustrates a use case of doctor treating patients in metaverse according to an embodiment of the disclosure.

Referring to FIG. 23, a doctor can have better control over medical tools and equipment while treating or operating a patient in metaverse or remote setup.

FIG. 24 illustrates a use case of shopping in metaverse according to an embodiment of the disclosure.

Referring to FIG. 23, a user can feel the weight of the products before shopping in metaverse. This can provide the user, an idea of how the product would feel in the real world.

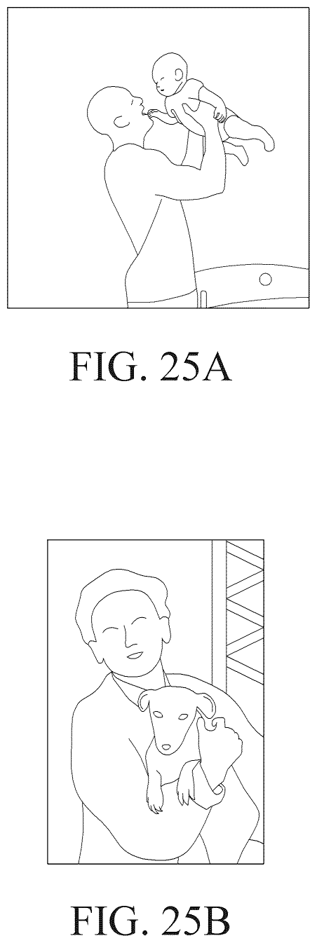

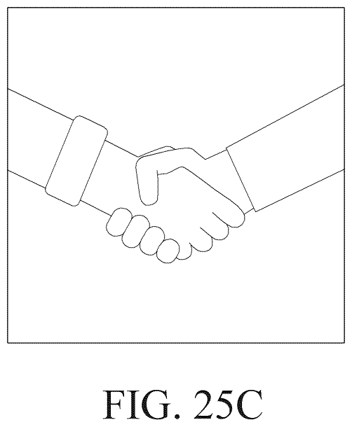

FIGS. 25A, 25B, and 25C illustrate a use case of people interacting in metaverse according to various embodiments of the disclosure.

Referring to FIGS. 25A, 25B and 25C, a user can feel a weight of the child or pet in the metaverse while holding and lifting them, as depicted in FIG. 25A. Alternately, when a non-parent avatar of a second user (e.g., a nanny) is interacting with a child or pet of a first user, the first user may feel the force or weight exerted by the non-parent avatar on the child or pet in the metaverse, as depicted in FIG. 25B. Further, a feeling of weight applied to one another while handshakes can be experienced, as depicted in FIG. 25C. This can give them feeling closer to reality.

Therefore, the proposed system 200 may enhance metaverse experience, and adoption of metaverse can increase with introduction of new modality (brings users more closer to reality). The proposed system 200 may enable a user to feel the weight of the virtual object 802 in real world which enhances user experience. The proposed system 200 may include the flow of the nano-magnetic particles 304 to different regions of user's hand replicating the absolute weight feeling of the virtual object 802 held by the user's avatar in metaverse.

The embodiments disclosed herein can be implemented through at least one software program running on at least one hardware device. The modules shown in FIG. 2 include blocks which can be at least one of a hardware device, or a combination of hardware device and software module.

The embodiment disclosed herein describes systems 200 and methods (1500, 1800, 1900, 2000) for enabling a user to feel a physical action experience of one or more virtual objects in a virtual world. Therefore, it is understood that the scope of the protection is extended to such a program and in addition to a computer readable means having a message therein, such computer readable storage means contain program code means for implementation of one or more operations of the method, when the program runs on a server or mobile device or any suitable programmable device. The method is implemented in at least one embodiment through or together with a software program written in e.g., very high speed integrated circuit hardware description language (VHDL) another programming language, or implemented by one or more VHDL or several software modules being executed on at least one hardware device. The hardware device may be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the disclosure may be implemented on different hardware devices, e.g., using a plurality of CPUs.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and detail may be made therein without departing from the spirit and scope of the disclosure as defined by the appended claims and their equivalents.

What is claimed is:

1. A method for enabling a physical action experience in a virtual world, the method comprising:
detecting, by virtual reality (VR) circuitry, an interaction between an avatar and one or more virtual objects or between one or more avatars in the virtual world;
recognizing, by the VR circuitry, that the interaction includes a physical action;
measuring, by the VR circuitry, a magnitude of the physical action; and
activating, by the VR circuitry, a wearable device for emulating the physical action and the magnitude of the physical action, in a real world, onto a user associated with the avatar.

2. The method of claim 1, wherein the physical action comprises at least one of a physical force, a pressure and a weight.

3. The method of claim 1,
wherein the interaction includes the physical action by the avatar on at least one virtual object in the virtual world,
wherein the interaction includes the physical action between a first avatar and a second avatar, and
wherein the magnitude of the physical action between the first avatar and the second avatar is applied onto a first user and a second user in the real world.

4. The method of claim 3,
wherein the emulating of the physical action and the magnitude exerted during the physical action in the real world comprises:
receiving, by a controller of the wearable device, information indicative of the magnitude of the physical action exerted onto the user associated with the avatar, and
controlling, by the controller, transfer of a specified quantity of nano-magnetic particles proportionate to the magnitude of the physical action to a wearable body device of the wearable device for allowing the user to feel an absolute weight of the at least one virtual object in the real world, and
wherein the wearable body device is wearable by the user on a specified body portion of the user.

5. The method of claim 4, wherein the controlling of the transfer of the specified quantity of nano-magnetic particles comprises:
separating, by the controller, the specified quantity of nano-magnetic particles from a plurality of nano-magnetic particles;
forwarding, by the controller, the separated specified quantity of nano-magnetic particles to an electromagnetic track of the wearable device; and
changing, by the controller, polarity of an array of electromagnets of the electromagnetic track for producing a desired magnetic acceleration to control motion of the specified quantity of nano-magnetic particles to the wearable body device.

6. The method of claim 4, further comprising:
calculating, by the controller, a center of mass of the at least one virtual object,
calculating, by the controller, at least one contact point of the at least one virtual object projected on the specified body portion of the user,
measuring, by the controller, a pressure applied at the at least one contact point,
mapping, by the controller, data of the calculated center of mass, the calculated at least one contact point, and the measured pressure, to the specified body portion of the user in the real world, and
distributing, by the controller, the specified quantity of nano-magnetic particles across the wearable body device according to the mapped data and the calculated at least one contact point of the at least one virtual object to attach the nano-magnetic particles onto the specified body portion of the user in the real world,
wherein the controller utilizes a three dimensional (3D) rigging method for mapping the data of the calculated center of mass, the calculated at least one contact point, and the measured pressure, to the specified body portion of the user in the real world, and
wherein the at least one contact point is calculated using geometry and center of mass of the at least one virtual object with respect to the specified body portion of the user.

7. The method of claim 6, further comprising:
verifying, by the controller, in case that the at least one contact point with respect to the specified body portion of the user changes when the at least one virtual object moves in the virtual world; and
changing, by the controller, accordingly strength and polarity of one or more programmable electromagnets of the wearable body device to distribute the nano-magnetic particles across the wearable body device, in case that the at least one contact point changes.

8. A wearable device for enabling a physical action experience from a virtual world, the wearable device comprising:
a wearable body device wearable by a user on a specified body portion of the user;
a storage for storing a plurality of nano-magnetic particles;
a pump operable for transferring the plurality of nano-magnetic particles from the storage to the wearable body device and vice-versa;
memory storing instructions; and
at least one controller, comprising processing circuitry, communicatively coupled to virtual reality (VR) circuitry and the memory,
wherein the instructions, when executed by the controller individually and/or collectively, cause the wearable device to:
receive information indicative of a magnitude of the physical action exerted onto the user associated with an avatar in the virtual world, and
control the pump to transfer a specified quantity of nano-magnetic particles proportionate to the magnitude of the physical action to the wearable body device for allowing the user to feel an absolute weight of at least one virtual object in a real world.

9. The wearable device of claim 8, wherein the physical action comprises at least one of a physical force, a pressure and a weight.

10. The wearable device of claim 8,
wherein the pump comprises a piston and a slicer for transferring the plurality of nano-magnetic particles,
wherein the piston and the slicer are arranged inside the storage,
wherein the instructions, when executed by the controller individually and/or collectively, cause the wearable device to:
control the piston for moving the plurality of nano-magnetic particles upwards towards the slicer and above a slicing point, and
control the slicer for separating the specified quantity of nano-magnetic particles from the plurality of nano-magnetic particles, and forwarding the separated specified quantity of nano-magnetic particles to an electromagnetic track.

11. The wearable device of claim 10,
wherein the electromagnetic track is designed in a hollow structure with an outer layer and an inner layer,
wherein the outer layer and the inner layer are each arranged with an array of electromagnets to produce a desired magnetic acceleration of the specified quantity of nano-magnetic particles to flow in a forward direction or in a backward direction, and
wherein the desired magnetic acceleration is produced by changing polarity of the array of electromagnets to control motion of the nano-magnetic particles.

12. The wearable device of claim 10,
wherein the nano-magnetic particles are distributed from the electromagnetic track to the wearable body device,
wherein the wearable body device is designed with a plurality of compartments where each compartment is designed in a hollow structure with an outer layer and an inner layer,
wherein the outer layer and the inner layer of each compartment are arranged with one or more programmable electromagnets, and
wherein the one or more programmable electromagnets arranged on outer layers of selected one or more compartments are deactivated to distribute the nano-magnetic particles from the electromagnetic track to attach to the inner layer of the selected one or more compartments of the wearable body device worn on the specified body portion of the user.

13. The wearable device of claim 12, wherein the instructions, when executed by the controller individually and/or collectively, cause the wearable device to:
calculate a center of mass of the at least one virtual object;
calculate at least one contact point of the at least one virtual object projected on the specified body portion of the user;
measure a pressure applied at the at least one contact point;
map data of the calculated center of mass, the calculated at least one contact point, and the measured pressure, to the specified body portion of the user in a real world; and
distribute the specified quantity of nano-magnetic particles across inner layers of the selected one or more compartments of the wearable body device according to the mapped data and the calculated at least one contact point of the at least one virtual object to attach the nano-magnetic particles onto the specified body portion of the user in the real world.

14. The wearable device of claim 13,
wherein the instructions, when executed by the controller individually and/or collectively, cause the wearable device to utilizes a three dimensional (3D) rigging method for mapping the map data of the calculated center of mass, the calculated at least one contact point, and the measured pressure, to the specified body portion of the user in the real world,
wherein the at least one contact point is calculated using geometry and center of mass of the at least one virtual object with respect to the specified body portion of the user, and
wherein when the at least one virtual object moves in the virtual world, the at least one contact point with respect to the specified body portion of the user changes and the controller accordingly changes strength and polarity of the one or more programmable electromagnets to distribute the nano-magnetic particles across the wearable body device.

15. One or more non-transitory computer-readable storage media storing one or more computer programs including computer-executable instructions that, when executed by at least one processor of a wearable device individually or collectively, the wearable device comprising communication circuitry, the executed instructions cause the wearable device to perform operations, the operations comprising:
detecting an interaction between an avatar and one or more virtual objects or between one or more avatars in a virtual world;
recognizing that the interaction includes a physical action;
measuring a magnitude of the physical action; and
activating the wearable device for emulating the physical action and the magnitude of the physical action, in a real world, onto a user associated with the avatar.

16. The one or more non-transitory computer-readable storage media of claim 15, wherein the physical action comprises at least one of a physical force, a pressure and a weight.

17. The one or more non-transitory computer-readable storage media of claim 15,
wherein the interaction includes the physical action by the avatar on at least one virtual object in the virtual world,
wherein the interaction includes the physical action between a first avatar and a second avatar, and
wherein the magnitude of the physical action between the first avatar and the second avatar is applied onto a first user and a second user in the real world.

18. The one or more non-transitory computer-readable storage media of claim 17,
wherein the emulating of the physical action and the magnitude exerted during the physical action in the real world, comprising:
receiving, by a controller of the wearable device, information indicative of the magnitude of the physical action exerted onto the user associated with the avatar, and
controlling, by the controller, transfer of a specified quantity of nano-magnetic particles proportionate to the magnitude of the physical action to a wearable body device of the wearable device for allowing the user to feel an absolute weight of the at least one virtual object in the real world, and
wherein the wearable body device is wearable by the user on a specified body portion of the user.

19. The one or more non-transitory computer-readable storage media of claim 18, wherein the controlling of the transfer of the specified quantity of nano-magnetic particles comprising:
separating, by the controller, the specified quantity of nano-magnetic particles from a plurality of nano-magnetic particles;
forwarding, by the controller, the separated specified quantity of nano-magnetic particles to an electromagnetic track of the wearable device; and
changing, by the controller, polarity of an array of electromagnets of the electromagnetic track for producing a desired magnetic acceleration to control motion of the specified quantity of nano-magnetic particles to the wearable body device.

20. The one or more non-transitory computer-readable storage media of claim 19, the operations further comprising
calculating, by the controller, a center of mass of the at least one virtual object,
calculating, by the controller, at least one contact point of the at least one virtual object projected on the specified body portion of the user,
measuring, by the controller, a pressure applied at the at least one contact point,
mapping, by the controller, data of the calculated center of mass, the calculated at least one contact point, and the measured pressure, to the specified body portion of the user in the real world, and
distributing, by the controller, the specified quantity of nano-magnetic particles across the wearable body device according to the mapped data and the calculated at least one contact point of the at least one virtual object to attach the nano-magnetic particles onto the specified body portion of the user in the real world,
wherein the controller utilizes a three dimensional (3D) rigging method for mapping the data of the calculated center of mass, the calculated at least one contact point, and the measured pressure, to the specified body portion of the user in the real world, and
wherein the at least one contact point is calculated using geometry and center of mass of the at least one virtual object with respect to the specified body portion of the user.
